(19) United States
(12) Patent Application Publication
(10) Pub. No.: US 2016/0110781 A1
(43) Pub. Date: Apr. 21, 2016

(54) CONCESSION PREORDERING FOR PICKUP OR DELIVERY DURING AN EVENT

(71) Applicant: EBAY INC., San Jose, CA (US)

(72) Inventors: Teresa Elizabeth Bedel, San Jose, CA (US); Michael Hwang, San Francisco, CA (US); Megan Marie Williams, San Jose, CA (US); William R. Clarke, San Jose, CA (US); April Van Scherpe, Foster City, CA (US)

(21) Appl. No.: 14/518,789

(22) Filed: Oct. 20, 2014

(51) Int. Cl. G06Q 30/06; H04W 4/02; G06Q 20/32; G06Q 10/02

(52) U.S. Cl. CPC G06Q 30/0601; G06Q 10/02; H04W 4/02; G06Q 20/322

(57) ABSTRACT

There is provided systems and method for concession preordering for pickup or delivery during an event. A user may attend an event at a venue and have purchased admission for the event. Prior to attending the event, the user may establish a preorder for concessions available at the venue, such as popcorn for a movie or drinks at a concert or sports game. Once the user arrives at the venue, the preorder may be loaded to the concessions device so that a merchant viewing the preorder may fulfill the preorder by preparing the items in the preorder. The user may be detected at the venue through the user's communication device or when the user scans their ticket for entry to the venue. The user may be alerted when the order is prepared and instructed to visit a location or request the items to be delivered.

### TECHNICAL FIELD

The present application generally relates to concession preordering for pickup or delivery during an event and more specifically to offering user an option to preorder concessions so that when the user arrives at an event location, their concession order may be retrieved and fulfilled so the user may pick up or have delivered the items in the order.

### BACKGROUND

Users may purchase tickets for events at venues, including movies, sporting events, concerts, and the like. Often, tickets are purchased well in advance of the event, and thus users plan accordingly for their arrival and experience at the event. However, the user may not be aware of the popularity of the event, or may run late as the event nears. Thus, when visiting a concessions stand to purchase items at the event, the user may waste time in a line while the event is occurring. In doing so, the user may miss important occurrences during the event that the user wishes to view or experience.

Users may utilize user devices, such as mobile phones, smart watches and glasses, and tablet computers, to purchase admission tickets for the event. The user devices enable the user to provide electronic proof of admission to the event. Additionally, these devices assist the user with payment for the tickets. However, while at the event, the user is often required to keep some form of payment instrument on them in order to pay for concessions. Thus, the user risks potential loss of the payment instrument and fraud by exposing themselves to loss and/or theft of the payment instrument.

### BRIEF DESCRIPTION OF THE DRAWINGS

FIG. 1 is a block diagram of a networked system suitable for implementing the process described herein, according to an embodiment;

FIG. 2 is an exemplary venue environment where a user arrives at a venue and a concessions preorder is prepared for the user, according to an embodiment;

FIG. 3 is an exemplary system environment displaying a user device establishing a concession preorder with a concessions device for fulfillment when the user is detected at a venue associated with the concessions device, according to an embodiment;

FIG. 4 is a flowchart of an exemplary process for concession preordering for pickup or delivery during an event, according to an embodiment; and

FIG. 5 is a block diagram of a computer system suitable for implementing one or more components in FIG. 1, according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

A user may purchase admission to an event at a venue, such as tickets to sporting events, concerts, shows, movies, etc. The user may utilize a mobile communication device, such as a mobile phone, to complete the purchase and may store the user's admission information for future reference when the user plans on attending the event. The user may also request physical admission tickets having a code that may be presented at the venue for admission. Once the user has arranged for admission to the event, the user may then create a concession preorder for the user when the event occurs.

The user may utilize a personal computer, mobile device, tablet computer, or other communication device in order to establish the concession preorder by accessing a merchant application for a merchant at the venue or a venue application listing available merchants at the venue. Such an application may also correspond to an Internet browser configured to allow access to a website corresponding to the merchant and/or venue. Once the user has accessed an ordering screen, item marketplace, or other online store, the user may make one or more selections of items the user would like to purchase for use or consumption during the event. For example, the use may view a menu of items available from a merchant at the venue and establish a preorder of items that the user would like to purchase. Once the user is satisfied with their preorder, the preorder may be established for fulfillment when the user is at the venue.

The preorder may be transmitted to a concessions device or server (e.g., a merchant's device/server utilized by the merchant to provide concessions during an event at a venue) that stored the order to one or more databases in a memory component of the device/server. The preorder may be associated with ticket information for the user and/or a user identifier or user communication device identifier that may be transmitted with the preorder or recalled from a database if the user has previously established a user account for preordering or submitted preorders with the merchant. In other embodiments, the user's communication device may store the preorder for transmission when the user arrives at the venue and/or requests the preorder to be fulfilled.

Once the user arrives at the venue, the concessions device/server may be informed of the user's arrival. In various embodiments, the user may be detected at the venue through an infrared or other ticket scanner, which may input the user's physical ticket or digital ticket displayed on an output device display of the user's communication device. Thus, once the ticket input device receives ticket information for admission of the user to the venue, the concessions device/server may be informed that the user has been admitted to the venue. In other embodiments, the user's communication device may inform the concessions device/server of the user's location at the venue through a communication module. The communication module may communicate GPS or other mapping coordinates. Such location information may also be transmitted to the concessions device/server from a third party source, such as a mapping server, a social networking provider, and/or a server for the venue. In other embodiments, the user's communication device may be detected at the venue using the communication module of the communication device and other devices established at the venue, including the concessions device. For example, the communication module may connect with one or more of the other devices using near field communications, Bluetooth, Bluetooth Low Energy, LTE Direct, WiFi, or other communication protocol. Thus, the communication device may include specialized hardware enabling short range communication with device at the venue. Where the user may request that a preorder is fulfilled after the user arrives at the venue, the user may utilize the communication device's input device(s) to enter a request to fulfill the preorder, which may be communicated to the concessions device. In another embodiment, the user's location may be used to estimate an arrival time at the event, such that the concessions device/server may have advance notice of an estimated arrival time, which may be especially useful for orders that require more time to fulfill and/or may be needed as soon as the user arrives at the event.

Once the user is detected at the venue (or the user has requested that their preorder is fulfilled), the concessions device may display the preorder to a merchant (or merchant employee) using an output device display. The merchant may prepare the preorder, for example, by preparing each item in the preorder and placing the items into a prepared order. Once completed, the merchant may utilize the concessions device (e.g., through an input device of the concessions device) to notify the user that the preorder is prepared and ready for pickup by the user. The concessions device may communicate with the user device using a communication module, and may provide location information for where the user may pick up the preorder. In other embodiments, the user may request that the preorder is delivered to a location for the user, such as a seating location. Such information may be included with the preorder, or may be communicated to the concessions device when the user is detected at the venue or requests the preorder to be prepared. The concessions device may display the delivery information to the merchant, and the merchant may deliver the preorder to the user. The user may receive the notification of fulfillment of the preorder through the communication device, and may view location information for pickup or an expected time for delivery and location of the delivery. The user's communication device may also receive information of other associated users at the venue (e.g., family, friends, etc.) from the concessions device, a server for the venue, and/or a third party source (e.g., a social networking platform). In other embodiments, a merchant may be notified of a preorder when a user leaves a seat at the event, such as during an intermission, restroom break, etc. As such, the preorder may be ready for the user when the user arrives at the location to pick up the preorder.

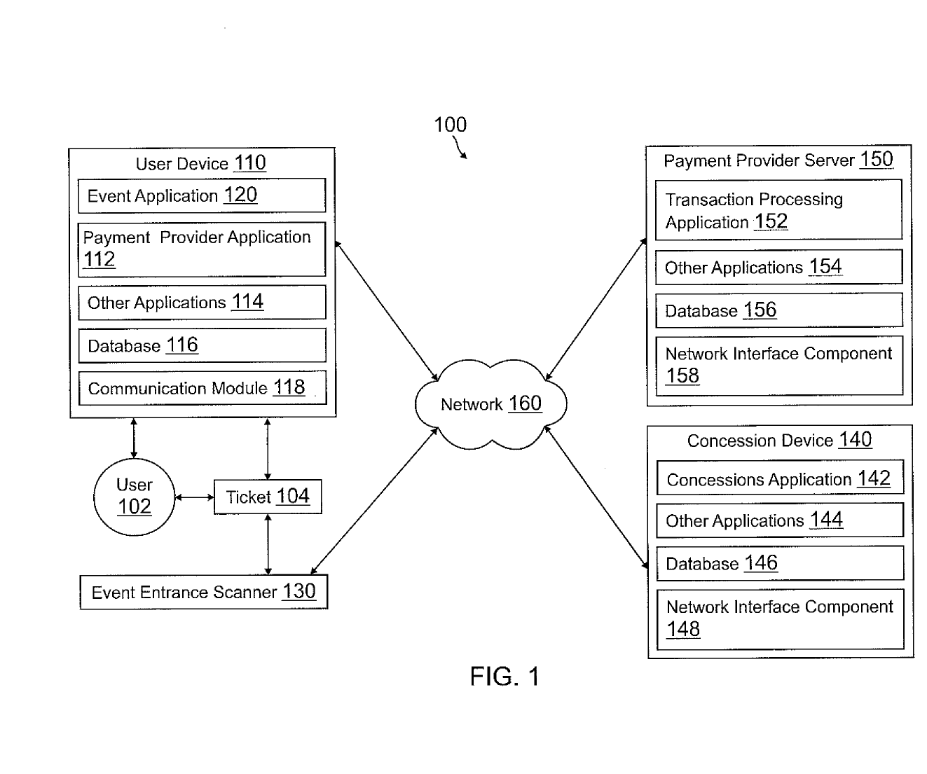

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, an event ticketing server 130, a concessions device 140, and a payment provider server 150 in communication over a network 160. User 102, such as a consumer, utilizes user device 110 to purchase admission to an event at a venue corresponding to concessions device 140. These actions may be facilitated by event ticketing server 130, concessions device 140, and/or payment provider server 150 in certain embodiments. As the event approaches, information corresponding to parameters of user 102 may be gathered by event ticketing server 130 through user device 110, concessions device 140, and/or payment provider server 150. Thus, purchase options may be offered to user 102 through user device 110 based on user 102's admission information and parameters. Purchase options may be determined using information from user device 110, event ticketing server 130, concessions device 140, and/or payment provider server 150.

User device 110, event entrance scanner 130, concessions device 140, and payment provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented as a communication device that may utilize appropriate hardware and software configured for wired and/or wireless communication with event entrance scanner 130, concessions device 140, and/or payment provider server 150. For example, in one embodiment, user device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a user device is shown, the user device may be managed or controlled by any suitable processing device. Although only one user device is shown, a plurality of user devices may function similarly.

User device 110 of FIG. 1 contains an event application 120, a payment provider application 112, other applications 114, a database 116, and a communication module 118. Event application 120, payment provider application 112, and other applications 114 may correspond to processes, procedures, and/or applications, for example, a software program, executable by a hardware processor. In other embodiments, user device 110 may include additional or different software as required.

Event application 120 may correspond to one or more processes to execute modules of user device 110 in order to purchase and/or reserve event tickets, transmit ticket information, place preorders, and/or request preparation of a preorder or identify user 102 at a venue. In this regard, event application 120 may be utilized to, for example, provide a convenient interface to permit a user to browse information available over network 160 and utilize services available from service providers, such as payment provider server 150 and/or event service provider devices/servers. In certain embodiments, event application 120 may be implemented as a web browser configured to view information available over the Internet or access a website of a service provider, including the event service provider, concessions device 140, and/or payment provider server 150. For example, event application 120 may be utilized to access websites and engage in online transactions with a service application. Additionally, event application 120 may access other service provider websites, such as payment provider server 150, to facilitate online payments, financial websites to view financial information and engage in financial transactions, messaging websites, social networking websites, and/or other online sources. In various embodiments, one or more of the described modules, features, and/or processes may be implemented in a separate application or component. Consequently, event application 120 may correspond to a plurality of applications and/or modules, each executing on their respective required hardware components.

Event application 120 may execute a first module (e.g., a ticket ordering module) of user device 110 utilized by user 102 to reserve and/or purchase tickets to an event, such as a movie, concert, sporting event, conference, or other type of event tickets. Such first module may utilize communication module 118 of user device 110 to communicate ticket data. Thus, event application 120 may be utilized to interact with a third party in order to reserve/purchase such tickets, such as through an event venue device/server, a reseller device/server (e.g., STUBHUB®, of San Francisco, Calif.), or a private party seller, which may offer such tickets for sale. Once user 102 has reserved event tickets, user 102 may then store ticket information to database 116 in a memory unit of user device 110 and/or provide the ticket information to an event venue device/server. The ticket information may also be provided to concessions device 140, for example, using communication module 118. Thus, user 102 may receive ticket 104, which may correspond to a physical ticket received after a reservation/purchase of a ticket to an event at a venue. In other embodiments, ticket 104 may constitute a digital ticket stored to user device 110, which may be displayable on an output display module of user device 110 or communicated to event entrance scanner 130 and/or concessions device 140 using communication module 118.

Event application 120 may execute a second module of user device 110 (e.g., an item preordering module for an event user 102 is attending at a venue) in order to create and establish a preorder for one or more items available from a merchant corresponding to concessions device 140 at a venue for concessions device 140. In this regard, event application 120 may receive information from a merchant server/device corresponding to the merchant, including concession device 140, that may include data of available items, such as a menu for the merchant. The data may be received by communication module 118 and may be displayable using art output display device of user device 110. User 102 may make selections of desired items using an input device of user device 110, such as a keyboard, touch screen, mouse, or other input device. Once user 102 has selected the items for the preorder, the preorder may be stored to database 116 in a memory of user device 110. The preorder may also be communicated using communication module 118 to the merchant's device/server, including concessions device 140, for storage and later recall when user 102 is located at the venue before or during the event.

Prior to or during the event user 102 has purchased ticket for; user 102 may travel to the event's venue in order to view or experience the event. As previously discussed, user 102 may bring ticket 104, which may correspond to a physical ticket that user 102 may utilize with event entrance scanner 130 in order to receive admission to the event at the venue, as will be discussed in more detail herein. In other embodiments, user 102 may utilize event application 120 to execute the first module and display purchase event admission tickets on an output display device of user device 110. User 102 may then utilize the displayed ticket with event entrance scanner 130 to receive admission to the event. In other embodiments, a venue employee may view ticket 104 and/or user device 110 to admit user 102. Additionally, the first module may utilize communication module 118 to transmit the event admission ticket to another device or server, including event entrance scanner 130, to admit user 102 to the event. Once user 102 is scanned as being admitted to the event, merchant device 140 may load the preorder for fulfillment by the merchant, as will be discussed in more detail herein.

In various embodiments, detection of user 102 at a venue that user 102 is attending to view/experience an event may be accomplished utilizing event application 120 and/or a location application/module, such as a GPS unit with associated software and location specialized hardware. Location information may be transmitted by event application 120 to an event, venue, and/or merchant device/server that may alert concessions device 140 of the proximity of user 102 to the venue. In other embodiments, the location information may be transmitted directly to concessions device 140. Event application 120 may also utilize communication module 118 to connect with one or more devices at the venue through short range wireless communications that may identify user 102 with the venue. Once concessions device is aware user 102 is at or nearby to the venue, a merchant or merchant employee for concessions device 140 may begin preparing the preorder for user 102.

Event application 120 may receive a notification that the preorder is prepared or being prepared by the merchant using communication module 118. Event application 120 may display the notification to user 102 through a device display interface. In various embodiments, the notification may include a time the items in the preorder will be prepared, a time the items in the preorder were prepared, a location for a concession booth, stand, or restaurant where user 102 may pick up the items, directions to the concessions area, an approximate wait time for the concessions area, order number or identification for the items in the preorder, and/or a scannable or enterable code (e.g., an bar code, QR code, and/or alphanumeric code) for release of the items in the preorder. User 102 may also enter delivery information for the items when either establishing the preorder or arriving at the venue, such as seating information or location information for user 102. Such delivery information may be communicated by user device 110 using communication module 118 to concessions device 140 for use in delivering the items to user 102, as will be explained in more detail herein. In various embodiments, event application 120 may also cause to be displayed delivery information, such as a delivery time, location, number, and/or courier identification and tracking. Where other users associated with user 102 (e.g., family and/or friends) are attending the venue, event application 120 may also cause to be displayed their identification, location, ticket information, and/or order/preorder information.

Payment provider application 112 may correspond to one or more processes to execute modules of user device 110 in order to provide an interface to display payment options for event tickets and/or a preorder for an event user 102 is attending. Payment provider application 112 may be implemented as an application having a user interface enabling the user to enter payment options for storage by user device 110, provide payment options on checkout/payment of a purchase order, and complete a transaction for the purchase order. Thus, payment provider application 112 may receive payment options from user 102 through an input device of user device 110 and/or from payment provider server 150, such as an account established by user 102. Payment provider application 112 may include further payment processes once user 102 has selected a payment instrument. For example, payment provider application 112 may provide a convenient interface to permit user 102 to select payment options and provide payment for items, such as event tickets and preorders. In this respect, payment application 112 may execute a payment module with modules of event application 120 in order to provide payment for items. Such payment module may provide a payment instrument for use with event application 120. The payment module may enable selection of a payment instrument, transmission of the payment instrument with the tickets or preorder for purchase, and receipt of a transaction history. In some embodiments, payment provider application 112 may correspond more generally to a web browser configured to view information available over the Internet or access a website corresponding to a payment application.

As discussed in reference to event application 102 and payment application 112, modules of such applications may include various software processes and corresponding hardware devices for execution of the described processes. Thus, an aforementioned module may include necessary software and specialized hardware components in order to provide assisted item preordering and detection of user 102 at a venue through user device 110. In various embodiments, described modules of event application 120 and payment application 112 may be incorporated in the same application so as to provide their respective features in one convenient application interface.

In various embodiments, user device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include financial applications, such as banking, online payments, money transfer, or other applications associated with payment provider server 150. Other applications may include mapping application, for example, through a GPS module that may identify user 102 at a location. Other applications may include short range wireless communication applications utilizing short range wireless modules, such as Bluetooth, WiFi, Bluetooth Low Energy, LTE Direct, near field communication, or other wireless communication module of communication module 118. Other applications 114 may contain software programs, executable by a processor, including a graphical user interface (GUI) configured to provide an interface to the user.

User device 110 may further include database 116 stored to a transitory and/or non-transitory memory of user device 110, which may store various applications and be utilized in such applications execution of various modules of user device 110. Thus, database 116 may include, for example, identifiers such as operating system registry entries, cookies associated with event application 120, payment provider application 112, and/or other applications 114, identifiers associated with hardware of user device 110, or other appropriate identifiers, such as identifiers used for payment/user/device authentication or identification. In certain embodiments, identifiers in database 116 may be used by an account provider, such as concessions device 140 and/or payment provider server 150, to associate user device 110 with a particular account maintained by the account provider. Database 116 may include admission information corresponding to admission for an event at a venue. Furthermore, database 116 may further include received information, such as item menus and transaction histories for preorder and admission ticket orders, as well as transmittable information, such as item preorders and admission ticket information.

In various embodiments, user device 110 includes at least one communication module 118 adapted to communicate with event entrance scanner 130, concessions device 140, and/or payment provider server 150 over network 160. In various embodiments, network interface component 118 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices. Communication module 118 may communicate directly with event entrance scanner 130 and/or short range wireless devices at a venue using short range communications, such as Bluetooth Low Energy, LTE Direct, radio frequency, infrared, Bluetooth, and near field communications. Thus, communication module 118 may include various specialized short range communication modules that may connect with nearby devices.

Event entrance scanner 130 may correspond to a physical device established at a venue having necessary hardware and software to perform acceptance of user 102's admission to the venue to view an event. In this regard, event entrance scanner may correspond to a turnstile that may admit user 102 to the venue to view/experience the event if user 102 is determined to have an acceptable event admission ticket for the event (e.g., ticket 104 or electronic ticker on user device 110). In other embodiments, event entrance scanner 130 may correspond to a smaller user device utilized by an employee of the venue to receive ticket 104 or electronic ticker on user device 110 and admit user 102 if the admission ticket is valid. Event entrance scanner 130 may include an optical scanner module, such as a camera and/or infrared scanning device. Event entrance scanner 130 may also include a communication module, which may communicate the admission or arrival of user 102 to one or more other devices or servers, including concessions device 140. Event entrance seamier 130 may also utilize the communication module to receive event admission ticket information from user device 110.

Concessions device 140 may correspond to a device utilized by a merchant for receiving orders of items at a venue, such as before, during, or after an event at the venue. Concessions device 140 may be maintained, for example, by a service provider offering available items for sale at the venue that user 102 may attend. Thus, concessions device 140 may offer items, products, and/or services corresponding to the venue and be maintained by anyone or any entity that receives money, which may include retailers and restaurants. Concessions device 140 may be implemented using any appropriate hardware and software configured for wired and/or wireless communication with user device 110, event entrance scanner 130, and/or payment provider server 150. Concessions device 140 may be implemented as a personal computer (PC), a smart phone, laptop computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a concessions device is shown, the payer device may be managed or controlled by any suitable processing device. Although only one concessions device is shown, a plurality of concessions devices may function similarly.

Concessions device 140 of FIG. 1 contains a concessions application 142, other applications 144, a database 146, and a network interface component 148. Concessions application 142 and other applications 144 may correspond to processes, procedures, and/or applications, for example, a software program, executable by a hardware processor. In other embodiments, concessions device 140 may include additional or different software as required.

Concessions application 142 may correspond to one or more processes to execute modules of user device 110 in order to provide item sales of items available from a merchant at or near the venue by the merchant. Thus, concessions application 142 may execute a concessions module that may include an application interface and/or API enabling user device 110 to access concessions device 140 and purchase from concessions device 140. Concessions application 142 may facilitate the exchange of money for items using user device 110 and/or payment provider server 150. More generally, concessions application 142 may provide services to user 102 over network 160, including information services for the items available at the venue. In this regard, concessions application 142 may further utilize a communication module/component of concessions device 140 (e.g., network interface component 148) to provide menus of merchant items, goods, products, and/or services for the merchant corresponding to concessions device 140 to user device 110. Concessions application 142 may facilitate the sale of items from the merchant, including payment to the merchant from user 102. Additionally, concessions application 142 may provide information for user 102 to find the merchant and pick up a preorder of items. Concessions application 142 may alert the merchant or merchant employee of user 102's location in order to provide delivery of purchased items to user 102. Transaction information corresponding to purchased items for a venue, such as by user 102, may be transmitted to user device 110 for use by user 102.

Thus, network interface component 148 may receive a preorder for processing by concessions application 142 executing a module of concessions device 140. The preorder may be received prior to user 102 arriving at the venue, when user 102 arrives at the venue, and/or when user 102 requests for the preorder to be fulfilled. Once the preorder is required to be fulfilled (e.g., on detection of user 102 at the venue), concession application 142 may cause the preorder to be displayed to the merchant or merchant employee using concessions device 140 through an output display device of concessions device 140. The merchant/employee may then fulfill the preorder so that the preorder is ready for release to user 102. The merchant/employee may then utilize an input device of concessions device 140 to communicate a notification that the preorder is ready. The notification may include a time the items in the preorder will be prepared, a time the items in the preorder were prepared, a location for a concession booth, stand, or restaurant where user 102 may pick up the items, directions to the concessions area, an approximate wait time for the concessions area, and order number or identification for the items in the preorder, and/or a scannable or enterable code (e.g., an bar code, QR code, and/or alphanumeric code) for release of the items in the preorder. Where user 102 has requested delivery of the preorder, concessions application 142 may be utilized to alert user 102 of the preparation and delivery of the order, the location for delivery, time for delivery, and courier information for the order. Concessions application 142 may also cause the delivery information to be displayed for use by the merchant, merchant employee, and/or courier.

Concessions application 142 may also execute the module to process payments from users, including user 102 for the preorder, using payment provider server 150. The module may utilize network interface component 148 to communicate with user device 110 and/or payment provider server 150 to receive a payment instrument and process a payment for the preorder using the payment instrument. Concessions application 142 may also cause the module to generate and transmit a transaction history to user 102 for the preorder. The transaction history may include transaction numbers, a bar/QR code, or other information for user 102 to use by user 102.

In various embodiments, user device 110 includes other applications 144 as may be desired in particular embodiments to provide features to user device 110. For example, other applications 144 may include security applications for implementing client-side security features, programmatic client applications for interfacing with appropriate application programming interfaces (APIs) over network 160, or other types of applications. Other applications may include mapping application, for example, through a GPS module that may identify a location for the merchant and assist user 102 in locating the physical location of the merchant. Other applications may include short range wireless communication applications utilizing short range wireless modules, such as Bluetooth, WiFi, Bluetooth Low Energy, LTE Direct, near field communication, or other wireless communication module of communication module 118. Other applications 144 may contain software programs, executable by a processor, including a graphical user interface (GUI) configured to provide an interface to the user.

Concessions device 140 includes database 146 stored to a transitory and/or non-transitory memory of concessions device 140, which may store various applications and be utilized in such applications execution of various modules of concessions device 140. In this regard, database 146 may include merchant menus, merchant information, and/or merchant locations. Database 146 may include received preorder for user 102, preorder information, such as delivery information, and payment information for user 102. Information in database 146 may be utilized by one or more of user device 110, event ticketing server 130, and/or payment provider server 150 to complete preorders for user 102.

In various embodiments, concessions device 140 includes at least one network interface component 146 adapted to communicate with network 160 including user device 110, event entrance scanner 130, and/or payment provider server 150. In various embodiments, network interface component 146 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices. Network interface component 148 may communicate directly with event entrance scanner 130 and/or short range wireless devices at a venue using short range communications, such as Bluetooth Low Energy, LTE Direct, radio frequency, infrared, Bluetooth, and near field communications, to receive an alert that user 102 has arrived at the venue. Thus, network interface component 148 may include various specialized short range communication modules that may connect with nearby devices.

Payment provider server 150 may be maintained, for example, by an online payment service provider, which may provide payment services and/or processing for financial transactions on behalf of user 102. In this regard, payment provider server 150 includes one or more processing applications which may be configured to interact with user device 110 and/or concessions device 140 to facilitate payment for a transaction. In one example, payment provider server 150 may be provided by PAYPAL®, Inc. of San Jose, Calif., USA. However, in other embodiments, payment provider server 150 may be maintained by or include a credit provider, financial services provider, financial data provider, and/or other service provider, which may provide payment services to user 102. Although payment provider server 150 is shown as separate from concessions device 140, it is understood the services provided by payment provider server 150 may be incorporated within concessions device 140 (e.g., transaction processing using a payment instrument).

Payment provider server 150 of FIG. 1 includes a transaction processing application 152, other applications 154, database 156, and a network interface component 158. Transaction processing application 152 may correspond to processes, procedures, and/or applications, for example, a software program, executable by a hardware processor. In other embodiments, payment provider server 150 may include additional or different software as required.

Transaction processing application 152 may execute one or more modules of payment provider server 150 to receive and/or transmit information from user device 110 and concessions device 140 for processing and completion of financial transactions for item preorders with a merchant corresponding to concessions device 140. In this regard, network interface component 158 may receive a request to complete a sale transaction for items/services/goods included in a preorder for user 102 with the merchant corresponding to concessions device 140. The request may correspond to a payment from user device 110 to concessions device 140. The payment may include a user account identifier (e.g., a payment account for user 102 with payment provider server 150) or other payment instrument (e.g. a credit/debit card or checking account). Additionally, the payment may include a payment amount and terms of payment. Transaction processing application 152 may complete the transaction by providing payment to concessions device 140. Additionally, transaction processing application 152 may utilize network interface component 158 to provide transaction histories, including receipts, to user device 110 and/or concessions device 140 for completion and documentation of the financial transaction.

Payment provider server 150 includes other applications 154 as may be desired in particular embodiments to provide features to payment provider server 150. For example, other applications 154 may include security applications for implementing server-side security features, programmatic server applications for interfacing with appropriate application programming interfaces (APIs) over network 160, or other types of applications. Other applications 154 may contain software programs, such as a graphical user interface (GUI), executable by a processor that is configured to provide an interface to a user. Other applications 154 may include account applications, including user account services, financial accounting services, and/or financial statement services.

Additionally, payment provider server 150 includes database 156 stored to a transitory and/or non-transitory memory of payment provider server 150, which may store various applications and be utilized in such applications execution of various modules of payment provider server 150. As previously discussed, user 102 may establish one or more user accounts with payment provider server 150. User accounts in database 156 may include user information, such as name, address, birthdate, payment/funding information, additional user financial information, and/or other desired user data. User 102 may link user accounts in database 156 to user device 110 through a user device identifier. Thus, when an identifier corresponding to user 102/user device 110 is transmitted to payment provider server 150 (e.g., from user device 110 and/or concessions device 140), a user account belonging to user 102 may be found. More generally, user accounts in database 156 may correspond to an account established by a user and maintained for engaging in online transactions. However, in other embodiments, user 102 may not have previously established a user account. Thus, payment provider server 150 may complete a transaction based on another payment instruments received from user device 110 and/or concessions device 140.

In various embodiments, payment provider server 150 includes at least one network interface component 158 adapted to communicate with user device 110 and/or concessions device 140 over network 160. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

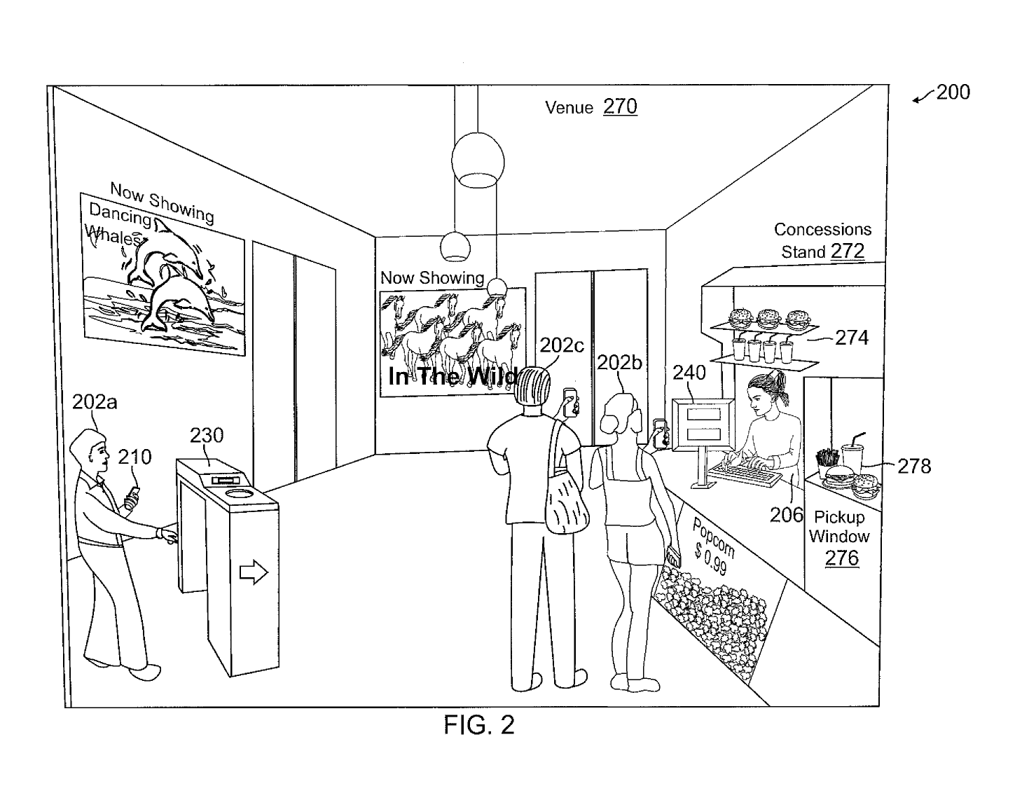

FIG. 2 is an exemplary venue environment where a user arrives at a venue and a concessions preorder is prepared for the user, according to an embodiment. Environment 200 of FIG. 2 includes a user 202a having a ticket 204 and a user device 210 corresponding generally to user 102, ticket 104, and user device 110, respectively, of FIG. 1. Additionally, environment 200 includes an event entrance scanner 230 and a concessions device 240 corresponding generally to event entrance scanner 130 and concessions device 140, respectively, of FIG. 1.

As shown in environment 200, user 202a arrives at a venue 270 where user 202a has an admission ticket to view an event. Venue 270 may correspond to a movie theater, concert hall, sports stadium, or other location where user 202a may view and experience an event (e.g., a movie, concert, sports game, etc.). When arriving at venue 270, user 202a may display ticket 204 to event entrance scanner 230 in order to gain admission to venue 270 and view the event. However, in other embodiments, user 202a may utilize user device 210 to enter venue 270 by, for example, displaying an admission ticket and/or transmitting ticket information to event entrance scanner 230. Using the admission of user 202a to venue 270, concessions device 240 may be alerted that user 202a is at venue 270. As previously discussed, user 202a may also be detected at venue 270 through user device 210 (e.g., through location information for user device 210 and/or connections established between user device 210 and short range wireless devices at venue 270.

Venue 270 includes a concessions stand 272 where a merchant may view concessions device 240 and utilize concessions device 240 when selling items 274. In environment 200, concessions stand 272 has a line with a user 202b and a user 202c. User 202a may have established a preorder with concessions device 240 that may be prepared and fulfilled when user 202a arrives at venue 270. Thus, after user 202a is detected at venue 270, concessions device 240 may populate the preorder for viewing by merchant 206 so that merchant 206 may fulfill the preorder from items 274. Merchant 206 may have fulfilled the preorder as order 278 in pick up window 276. Thus, user 202a may bypass the line having users 202b and 202c and directly pick up order 278, saving user 202a time while at venue 270 and avoiding creation of long lines.

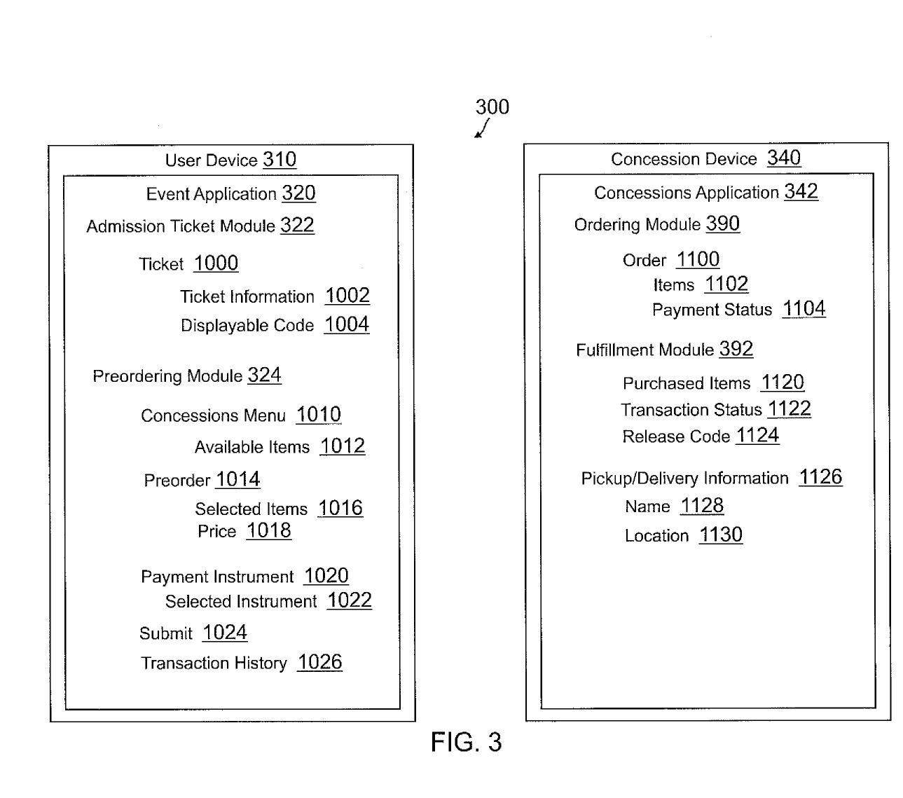

FIG. 3 is an exemplary system environment displaying a user device establishing a concession preorder with a concessions device for fulfillment when the user is detected at a venue associated with the concessions device, according to an embodiment. Environment 300 includes a user device 310 and a concessions device 340 corresponding generally to user device 110 and concessions device 140, respectively, of FIG. 1.

User device 310 executes an event application 320 corresponding generally to the executable modules described in reference to event application 320 of FIG. 1. Event application 320 executes two modules of user device 310, an admission ticket module 322 that may utilize software and hardware of user device 310 to establish and maintain an event admission ticket to an event at a venue, and a preordering module that may utilize software and hardware of user device 310 to generate and communicate a preorder of one or more available items at the venue during the event. In this regard, admission ticket module 322 includes information for a ticket 1000, such as ticket information 1002 (e.g., time, location, seating, price, and/or other information for the event ticket) and displayable code 1004 (e.g., a code utilized to gain admission to the event at the venue).

Preordering module 324 includes information displayable to a user of user device 310 and process necessary to generate and communicate a preorder using the displayable information. Thus, preordering module 324 includes a concessions menu 1010 having available items 1012. Concessions menus 1010 may therefore display available items 1012 for selection by the user. Once the user has selected one or more of available items 1012, preorder 1014 may be generated having selections items 1016 and a price 1018. The user may complete a payment for preorder 1014 using payment instrument 1020 having a selected instrument 1022, such as a financial account, payment account, payment card, or other financial payment instrument (e.g., gift cards, coupons, etc.). The user may utilize preordering module 324 to submit preorder 1014 by selecting submit 1024 option. Selection of submit 1024 option may engage a communication module of user device 310 to communicate preorder 1014 and payment instrument 1020 to concessions device 340. Once the preorder is communicated and payment is completed, user device 310 may receive a transaction history 1026, which may include a code or other information assisting the user in retrieval of preorder 1014 once the preorder is fulfilled.

Concessions device 340 executes a concessions application 342 corresponding generally to the executable modules described in reference to concessions application 142 of FIG. 1. Concessions application 342 executes an ordering module 390 of concessions device 340 that may utilize software and hardware of concessions device 340 in order to receive orders from people at a concessions stand and complete a payment for the orders. In this regard, ordering module 390 includes order information that may be input by a merchant or merchant employee using an input device and output on a display device for concessions device 340 in order to fulfill the order. The order information may be displayed under order 1100, such as items 1102 and payment status 1104. Moreover, concessions application 342 executes a fulfillment module 392 that may receive preorders and process/display the preorder when their corresponding user is detected at a venue for an event. Thus, fulfillment module 392 includes received purchase items 1120 from a preorder that includes a transaction status 1122 and a release code 1124. Once the user is detected at the venue, purchase items 1120 may be loaded and displayed for fulfillment by the merchant or merchant employee using concessions application 342. Moreover, pick up/delivery information 1126 may be displayed, such as a name 1128 of the user for the preorder and a location 1130 for the user or the pickup location the user has specified.

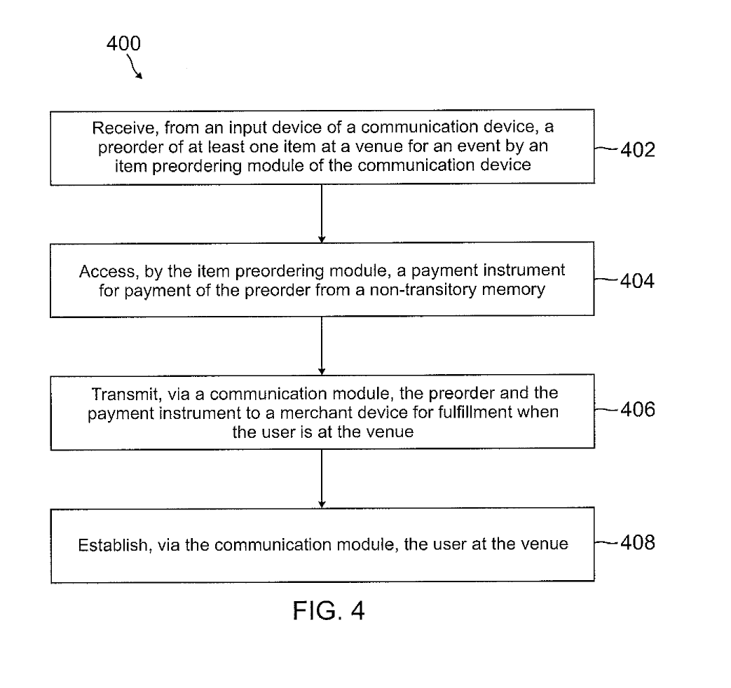

FIG. 4 is a flowchart of an exemplary process for concession preordering for pickup or delivery during an event, according to an embodiment. Note that one or more steps, processes, and methods described herein may be omitted, performed in a different sequence, or combined as desired or appropriate.

At step 402, a preorder of at least one item is received, from an input device of a communication device, for an event at a venue by an item preordering module of the communication device. For example, a communication device may comprise at least one input device for receiving the concession preorder from a user, an input/output interface in communication with the input device and, for example, at least one output device used to communication a notification to the user. The communication device may further comprises a non-transitory memory storing the preordering module and the concession preorder for the user, as well as, in various embodiments, a payment instrument, such as payment account information for a payment account with a payment provider. The communication device may also comprise at least one hardware processor in communication with the non-transitory memory for executing the preordering module to access the concession preorder for the user from the non-transitory memory and a communication module comprising a network interface. The preorder may comprise a request for at least one item available from a merchant at the event venue.

The payment instrument may be accessed, by the item preordering module and from the non-transitory memory, for payment of the preorder, at step 404. The payment instrument may comprise the payment account, a payment card, a financial account, a gift card or coupon, or other method of payment. Thus, at step 206, the preorder and the payment instrument is transmitted, via the communication module to a merchant device for fulfillment when the user is at the venue. The merchant device may correspond to a concessions device at a concessions stand or store at the venue. The merchant may prepare the preorder on detection of the user at the event venue. Thus, the user may also communicate delivery information for the preorder to the merchant device via the communication module, such as seating information from a digital ticket or input seating information from a physical ticket.

At step 408, the user is established at the venue, via the communication module. The communication module may connect to one of a wireless beacon, the concessions device, and a server for the venue to establish the user at the venue. In other embodiments, the user may be detected at the venue when presenting an admission ticket for a movie or event at the venue to a ticket scanner, which may notify the merchant device of the user's arrival at the venue. Once established at the venue and after the preorder is fulfilled, the user may receive a notification that the preorder is fulfilled via the communication module of the communication device. The merchant may place items in the preorder in a window for pickup by the user or may deliver the items to the user. The notification may comprise a location within the venue for the pickup window or may include delivery information. If the user picks up the items, the user may display a transaction history on an output device of the communication device in order to receive the items. Additionally, once the user is established at the venue, the user may receive notifications that an associated user is that the venue, with location information for the associated user (e.g., a GPS coordinate of the associated user, ticket information for the associated user, a location for the associated user's order/preorder, etc.).

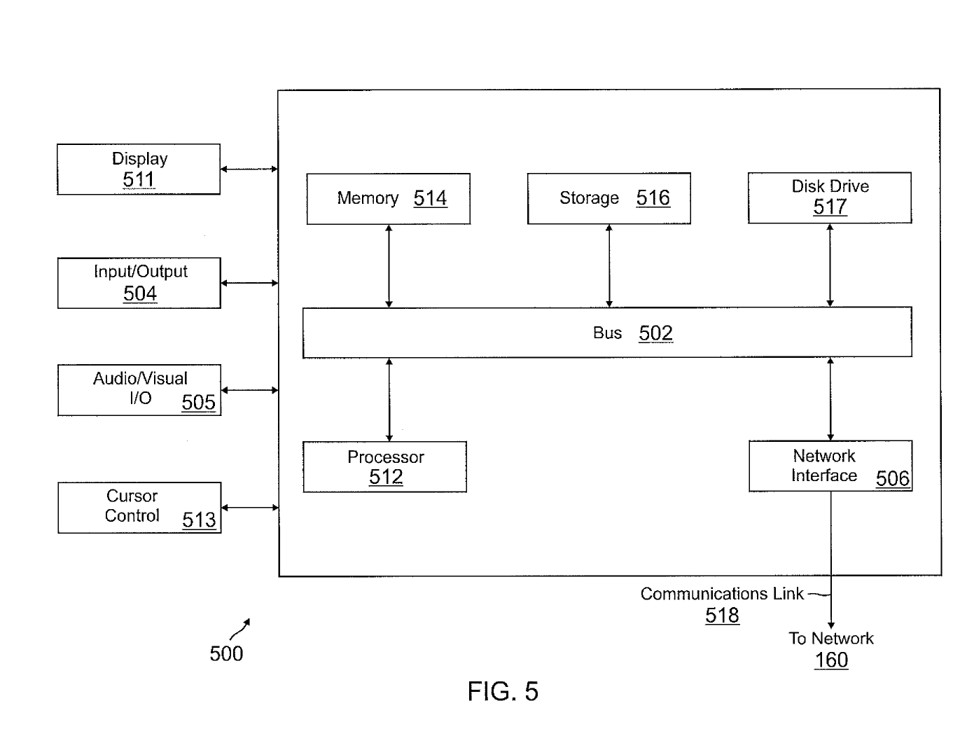

FIG. 5 is a block diagram of a computer system 500 suitable for implementing one or more embodiments of the present disclosure. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
an input device for receiving a concession preorder from a user;
an output device for communicating a notification to the user;
an input/output (i/o) interface in communication with the input device and the output device;
a non-transitory memory storing a preordering module and the concession preorder for the user;
at least one hardware processor in communication with the non-transitory memory for executing the preordering module to access the concession preorder for the user from the non-transitory memory; and
a communication module comprising a network interface that communicates, to a concessions device for an event venue, the concession preorder for fulfillment by a merchant on detection of the user at the event venue, receives the notification that the concession preorder is fulfilled,
wherein the at least one output device displays the notification to the user.

2. The system of claim 1, wherein the non-transitory memory further stores payment account information for a payment account with a payment provider, and wherein prior to the communication module receiving the notification, the communication module further the payment account information to the concessions device for payment of the concession preorder.

3. The system of claim 1, wherein the preorder comprises a request for at least one item available from a merchant at the event venue.

4. The system of claim 3, wherein the merchant places the at least one item in the concessions order at a pickup window at the event venue

5. The system of claim 4, wherein the notification comprises a location within the event venue for the pickup window.

6. The system of claim 5, wherein the user presents a transaction history for the concessions preorder to at least one of the merchant, the concessions device, and an employee of the event venue for retrieval of the at least one item by the user.

7. The system of claim 6, wherein the notification comprises the transaction history, and wherein the transaction history comprises a code for presentation to the at least one of the merchant, the concessions device, and the employee of the event venue.

8. The system of claim 3, wherein prior to the communication module receiving the notification, the communication module further communicates, to the concessions device, delivery information for the at least one item to the user at the event venue.

9. The system of claim 8, wherein the delivery information comprises seating information for the user at the venue.

10. The system of claim 9, wherein a digital ticket comprises the seating information, and wherein the digital ticket is stored by the non-transitory memory.

11. The system of claim 9, wherein the at least one input device receives the seating information from the user.

12. The system of claim 1, wherein prior to the communication module receiving the notification, the user presents an admission ticket for a movie or event at the event venue to a ticket scanner for an entrance to the event venue, and wherein the ticket scanner notifies the concessions device that the user is at the event venue.

13. The system of claim 12, wherein the admission ticket comprises one of a digital ticket displayable by the output device and a physical ticket held by the user.

14. The system of claim 1, wherein the input device and the output device comprises a single input/output (i/o) device.

15. A method comprising:
receiving, from an input device of a communication device, a preorder of at least one item at a venue for an event by an item preordering module of the communication device;
accessing, by the item preordering module, a payment instrument for payment of the preorder from a non-transitory memory of the communication device;
transmitting, via a communication module, the preorder and the payment instrument to a concessions device for fulfillment when the user is at the venue; and
establishing, via the communication module, the user at the venue.

16. The method of claim 15, wherein the communication module connects to one of a wireless beacon, the concessions device, and a server for the venue to establish the user at the venue.

17. The method of claim 15, wherein the communication module communicates with a mapping system to establish a location for the user, and wherein the communication module provides the location to one of a wireless beacon, the concessions device, and a server for the venue to establish the user at the venue to establish the user at the venue.

18. The method of claim 15, wherein the mapping system comprises on of an external server check-in by the communication device and a GPS module of the communication device.

19. The method of claim 15 further comprising:
receiving, via the communication module, a notification that an associated user is at the venue; and
displaying, through an output display interface, the notification to the user.

20. A non-transitory computer-readable medium comprising executable modules which, in response to execution by a computer system, cause the computer system to perform a method comprising:
receiving, from an input device of the computer system, a preorder of at least one item at a venue for an event by an item preordering module of a communication device;
receiving, from the input device, a payment instrument for the preorder by the item preordering module;
communicating, via a communication module of the computer system, the preorder and the payment instrument to a concessions device for fulfillment when the user is at the venue; and
receiving, from the communication module, a notification that the preorder is fulfilled.
